(19) United States
(12) Patent Application Publication
(10) Pub. No.: US 2021/0305632 A1
(43) Pub. Date: Sep. 30, 2021

(54) ENERGY STORAGE DEVICE

(71) Applicants: GS Yuasa International Ltd., Kyoto-shi (JP); Blue Energy Co., Ltd., Kyoto-shi (JP)

(72) Inventors: Taisei SEKIGUCHI, Kyoto (JP); Yudai KAWASOE, Kyoto (JP); Jun NAKAMURA, Kyoto (JP); Kazushi NITTA, Kyoto (JP)

(21) Appl. No.: 17/207,980

(22) Filed: Mar. 22, 2021

(30) Foreign Application Priority Data
Mar. 25, 2020 (JP) 2020-054001
Mar. 12, 2021 (JP) 2021-040556

(51) Int. Cl. H01M 10/0587; H01M 4/133; H01M 50/449; H01M 10/0585

(52) U.S. Cl. CPC H01M 10/0587; H01M 4/133; H01M 10/052; H01M 10/0585; H01M 50/449

(57) ABSTRACT

An energy storage device according to an aspect of the present invention includes: a winding type electrode assembly including a negative electrode containing a negative active material, a positive electrode, and a separator disposed between the positive electrode and the negative electrode; a case housing the electrode assembly; and a spacer disposed between the electrode assembly and an inner surface of the case in the case, wherein the separator includes a wet film, the negative active material is a carbonaceous material or lithium titanate, and the spacer is harder than the separator.

### FIELD

The present invention relates to an energy storage device.

The present application claims priorities based on Japanese Patent Application No. 2020-054001 filed on Mar. 25, 2020 and Japanese Patent Application No. 2021-040556 filed on Mar. 12, 2021, and the entire contents of the applications are incorporated herein by reference.

### BACKGROUND

JP 2014-220079 A describes an energy storage apparatus including a case, and an electrode assembly housed in the case, and having a layered structure in which a first electrode and a second electrode having a polarity different from that of the first electrode are insulated by a separator. The separator includes a first separator, and a second separator having a ceramic layer. The second separator and the first separator are disposed in this order with the first electrode or the second electrode sandwiched therebetween.

### SUMMARY

An object of the present invention is to provide an energy storage device in which a space of a winding center portion of an electrode assembly is relatively small and an increase in the air permeance of a separator including a wet film is suppressed.

An aspect of the present invention is an energy storage device including: a winding type electrode assembly including a negative electrode containing a negative active material, a positive electrode, and a separator disposed between the positive electrode and the negative electrode; a case housing the electrode assembly; and a spacer disposed between the electrode assembly and an inner surface of the case in the case, wherein the separator includes a wet film, the negative active material is a carbonaceous material or lithium titanate, and the spacer is harder than the separator.

### BRIEF DESCRIPTION OF DRAWINGS

FIG. 1 is a perspective view of an energy storage device according to the present embodiment.

FIG. 2 is a schematic cross-sectional view of a position of line II-II in FIG. 1.

FIG. 3 is a schematic cross-sectional view of a position of line III-III in FIG. 1.

FIG. 4 is a perspective view of a winding type electrode assembly of an energy storage device according to the present embodiment.

FIG. 5 is a schematic view of an energy storage apparatus including a plurality of energy storage devices according to the present embodiment.

### DESCRIPTION OF EMBODIMENTS

An aspect of the present invention is an energy storage device including: a winding type electrode assembly including a negative electrode containing a negative active material, a positive electrode, and a separator disposed between the positive electrode and the negative electrode; a case housing the electrode assembly; and a spacer disposed between the electrode assembly and an inner surface of the case in the case, wherein the separator includes a wet film, the negative active material is a carbonaceous material or lithium titanate, and the spacer is harder than the separator.

In the energy storage device according to an aspect of the present invention, a space of a winding center portion of the electrode assembly is relatively small and an increase in the air permeance of the separator including the wet film is suppressed.

First, an energy storage device disclosed in the present specification will be generally described.

According to an aspect of the present invention, there is provided an energy storage device 1 including: a winding type electrode assembly 2 including a negative electrode containing a negative active material, a positive electrode, and a separator 60 disposed between the positive electrode and the negative electrode; a case 3 housing the electrode assembly 2; and a spacer 70 disposed between the electrode assembly 2 and an inner surface of the case in the case 3, wherein the separator 60 includes a wet film, the negative active material is a carbonaceous material or lithium titanate, and the spacer 70 is harder than the separator 60.

The energy storage device 1 includes the winding type electrode assembly 2. In the winding type electrode assembly 2, a space z is formed in a winding center portion. In general, the innermost portion of such an electrode assembly 2 may be deformed so as to protrude toward the side of the space z of the winding center portion, so that a distance between the positive electrode and the negative electrode in the deformed inner portion may increase. Therefore, in the winding type electrode assembly 2 housed in the case 3, it is desired that the space z of the winding center portion is as small as possible.

Therefore, as in the present embodiment, a relatively hard spacer 70 (gap filling member) is disposed between the case 3 and the electrode assembly 2, whereby the space z of the winding center portion can be decreased according to the amount of the spacer 70 disposed. Therefore, in the energy storage device 1 of the present embodiment, the space z of the winding center portion of the electrode assembly 2 is relatively small.

However, the electrode assembly 2 housed in the case 3 may expand during charge and discharge, so that a reaction force during the expansion of the electrode assembly 2 causes the inner surface of the case 3 to press the electrode assembly 2 from the outside. Therefore, pores of the separator 60 collapse, which may cause an increase in the air permeance of the separator 60. In particular, the separator 60 includes the wet film, so that many pores have a bent shape in the wet film, which is apt to disadvantageously cause the increase in the air permeance due to the collapse of the pores.

Meanwhile, as in the present embodiment, the negative active material is the carbonaceous material or lithium titanate having a small expansion coefficient, whereby the expansion of the electrode assembly 2 can be suppressed. The expansion of the electrode assembly 2 can be suppressed, whereby pressing of the electrode assembly 2 by the inner surface of the case by the reaction force of the expansion force can be suppressed. This makes it possible to suppress the collapse of the pores of the wet film to suppress the increase in the air permeance of the separator.

Thus, in the energy storage device 1 of the present embodiment, the space z of the winding center portion of the electrode assembly 2 is relatively small, and the increase in the air permeance of the separator including the wet film is suppressed.

Here, the negative active material may be non-graphitic carbon as the carbonaceous material.

This can more sufficiently suppress the expansion of the negative active material, whereby, for the same reason as described above, the increase in the air permeance of the separator including the wet film can be further suppressed.

The case 3 may be held so as to have a constant size. In this case, the air permeance of the separator may be apt to increase.

For example, if the case is held so as to have a constant size when the electrode assembly which occupies most of the internal volume of the case 3 is housed in the case 3, the inner surface of the case 3 may apply a relatively large pressure (reaction force) to the electrode assembly 2. This pressure (reaction force) is apt to cause the pores of the wet film to collapse, which may be apt to cause the increase in the air permeance of the separator 60.

Thus, the case 3 is held so as to have a constant size, whereby the energy storage device 1 in which the air permeance of the separator 60 may be apt to increase has the above-described constitution (the negative active material is the carbonaceous material or the lithium titanate), and therefore, an effect of suppressing the increase in the air permeance of the separator 60 can be particularly expected.

When each of the spacer 70 and the separator 60 is compressed at a load of 7 kN by an indenter having a surface area of 3680 mm², the displacement amount of the separator 60 may be more than that of the spacer 70 by 0.1 mm/mm or more.

By using the spacer 70 having a displacement amount equal to or less than that of the separator 60 by a predetermined value as described above, a compressive force is less likely to deform the spacer 70. Accordingly, the electrode assembly 2 may receive a larger reaction force when the electrode assembly 2 expands from the spacer 70. This force is apt to cause the pores of the wet film to collapse, which may be apt to cause the increase in the air permeance of the separator 60.

Thus, the energy storage device 1 in which the air permeance of the separator 60 may be apt to increase has the above-described constitution (the negative active material is the carbonaceous material or the lithium titanate), whereby an effect of suppressing the increase in the air permeance of the separator 60 can be particularly expected.

The case 3 may be made of a metal, and include an insulating sheet which covers the electrode assembly 2 and insulates between the electrode assembly 2 and the case 3, and the spacer 70 may be disposed between the electrode assembly 2 and the insulating sheet.

Since the case 3 is made of the metal, the strength of the case 3 is high, whereby the case 3 is less likely to be deformed even when the electrode assembly 2 expands. Therefore, the inner surface of the case is apt to further press the electrode assembly 2, which is apt to further cause the increase in the air permeance of the separator 60. Therefore, by applying the present invention to the energy storage device of such an aspect, an advantage that the increase in the air permeance of the separator 60 is suppressed is particularly effectively obtained.

The constitution of the nonaqueous electrolyte energy storage device 1 according to one embodiment of the present invention, the constitution of the nonaqueous electrolyte energy storage apparatus, the method for manufacturing the nonaqueous electrolyte energy storage device 1, and other embodiments will be described in detail. The name of each constituent member (each constituent element) used in each embodiment may be different from the name of each constituent member (each constituent element) used in the background art.

<Constitution of Nonaqueous Electrolyte Energy Storage Device>

The nonaqueous electrolyte energy storage device 1 (hereinafter, also simply referred to as an “energy storage device”) according to an embodiment of the present invention includes an electrode assembly 2 including a positive electrode 40, a negative electrode 50, and a separator 60, a nonaqueous electrolyte, and a case 3 housing the electrode assembly 2 and the nonaqueous electrolyte. The electrode assembly 2 is a winding type (hereinafter, described in detail) electrode assembly in which the positive electrode 40 and the negative electrode 50 are wound in a laminated state where a separator 60 is interposed therebetween. The nonaqueous electrolyte is present in a state of being contained in the positive electrode 40, the negative electrode 50, and the separator 60. Hereinafter, a nonaqueous electrolyte secondary battery (particularly, a lithium ion secondary battery, hereinafter also simply referred to as a “secondary battery”) will be described as an example of the nonaqueous electrolyte energy storage device, but it is not intended to limit the scope of the present invention.

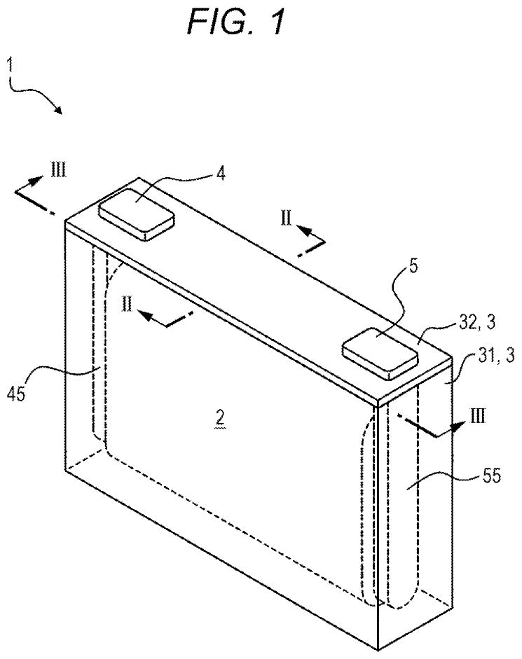

As shown in FIGS. 1 to 4, the energy storage device 1 of the present embodiment includes the winding type electrode assembly 2 in a wound state and the case 3 housing the electrode assembly 2. The energy storage device 1 includes two external terminals (a positive electrode terminal 4 and a negative electrode terminal 5) which are attached to the case 3 with at least a part thereof exposed, or are composed of at least a part of the case 3. The electrode assembly 2 is connected to each of the external terminals 4 and 5 via a current collector or the like in the case 3.

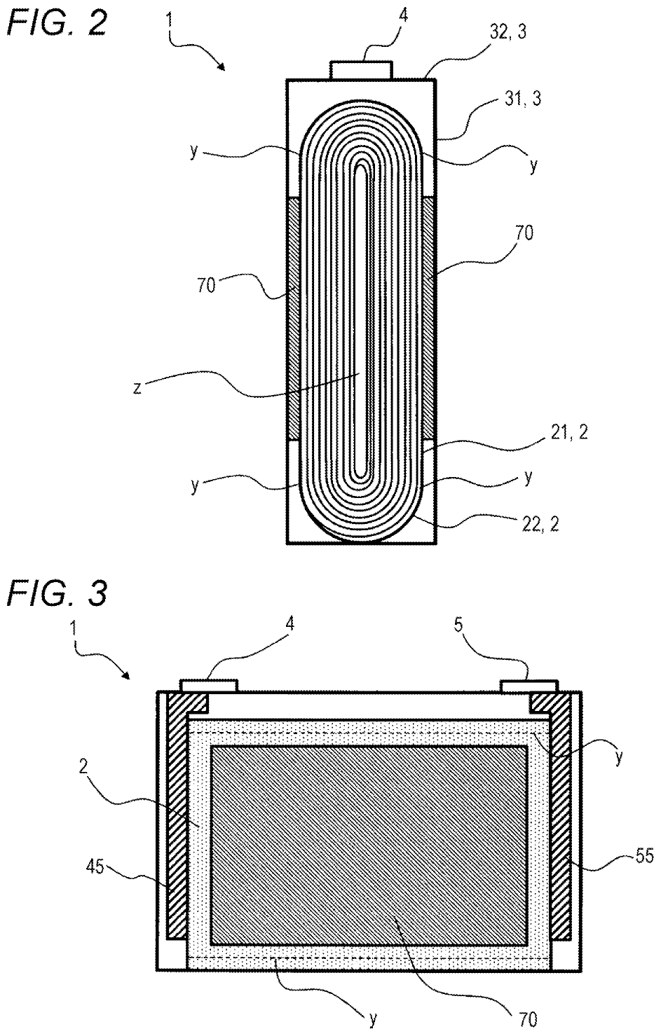

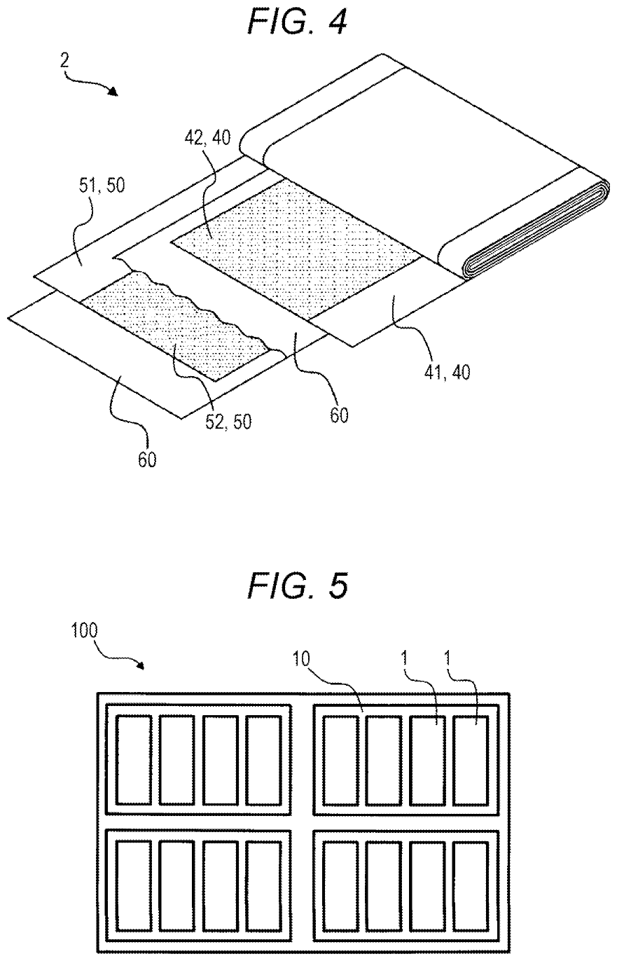

As shown in FIG. 4, the electrode assembly 2 is formed by stacking a long sheet-shaped positive electrode 40, a long sheet-shaped negative electrode 50, and two sheet-shaped separators 60 and 60, followed by winding. The two separators 60 and 60 are disposed so as to electrically insulate the positive electrode 40 and the negative electrode 50 from each other. In the present embodiment, the electrode assembly 2 is a flat wound body. The electrode assembly 2 is disposed in the case 3 so that the winding axis direction of the electrode assembly 2 is the same as a direction perpendicular to the opening direction of a case body 31. As shown in FIG. 2, a space z is slightly formed in the winding center portion of the electrode assembly 2.

(Positive Electrode)

The positive electrode 40 includes a positive electrode substrate 41 and a positive active material layer 42 directly disposed on the positive electrode substrate 41, or disposed on the positive electrode substrate 41 with an intermediate layer (not shown) interposed therebetween. In the present embodiment, the positive active material layer 42 is stacked on each of both surfaces of the positive electrode substrate 41. The positive active material layer 42 causes a charge-discharge reaction with a negative active material layer 52.

The positive electrode substrate 41 has conductivity. Whether or not the positive electrode substrate 41 has “conductivity” is determined with a volume resistivity of 10⁷ Ω·cm measured in accordance with JIS-H-0505 (1975) as a threshold value. As the material of the positive electrode substrate 41, metals such as aluminum, titanium, tantalum, and stainless steel, or alloys thereof are used. Among these, aluminum or an aluminum alloy is preferable from the viewpoint of potential resistance, conductivity level, and cost. Examples of the positive electrode substrate 41 include a foil and a deposited film, and a foil is preferable from the viewpoint of cost. Therefore, the positive electrode substrate 41 is preferably an aluminum foil or an aluminum alloy foil. Examples of aluminum or the aluminum alloy include A1085 and A3003 specified in JIS-H-4000 (2014).

The average thickness of the positive electrode substrate 41 is preferably 3 μm or more and 50 μm or less, more preferably 5 μm or more and 40 μm or less, still more preferably 8 μm or more and 30 μm or less, and particularly preferably 10 μm or more and 25 μm or less. By setting the average thickness of the positive electrode substrate 41 to the above range, the strength of the positive electrode substrate 41 and the energy density per volume of the secondary battery can be increased.

The intermediate layer is a layer disposed between the positive electrode substrate 41 and the positive active material layer 42. The intermediate layer contains particles having conductivity such as carbon particles to reduce contact resistance between the positive electrode substrate 41 and the positive active material layer 42. The constitution of the intermediate layer is not particularly limited, and includes, for example, a resin binder and particles having conductivity.

The positive active material layer 42 contains a positive active material. The positive active material layer 42 contains optional components such as a conductive agent, a binder (binding agent), a thickener, and a filler as necessary.

The positive active material can be appropriately selected from known positive active materials. As the positive active material for lithium ion secondary battery, a material capable of inserting and extracting lithium ions is usually used. Examples of the positive active material include a lithium transition metal composite oxide having an α-NaFeO₂ type crystal structure, a lithium transition metal composite oxide having a spinel type crystal structure, a polyanion compound, a chalcogenide, and sulfur. Examples of the lithium transition metal composite oxide having an α-NaFeO₂ type crystal structure include Li[LiₓNi₍₁₋ₓ₎]O₂ (0≤x<0.5), Li[LiₓNi_{γ}Co_{(1-x-γ)}]O₂ (0≤x<0.5, 0<γ<1), Li[LiₓCo₍₁₋ₓ₎]O₂ (0≤x<0.5), Li[LiₓNi_{γ}Mn_{(1-x-γ)}]O₂ (0≤x<0.5, 0<γ<1), Li[LiₓNi_{γ}Mn_{β}Co_{(1-x-γ-β)}]O₂ (0≤x<0.5, 0<γ, 0<β, 0.5<γ+β<1), and Li[LiₓNi_{γ}Co_{β}Al_{(1-x-γ-β)}]O₂ (0≤x<0.5, 0<γ, 0<β, 0.5<γ+β<1). Examples of the lithium transition metal composite oxide having a spinel-type crystal structure include LiₓMn₂O₄ and LiₓNi_{γ}MnNi_{γ}Mn_{(2-γ)}O₄. Examples of the polyanion compound include LiFePO₄, LiMnPO₄, LiNiPO₄, LiCoPO₄, Li₃V₂(PO₄)₃, Li₂MnSiO₄, and Li₂CoPO₄F. Examples of the chalcogenide include titanium disulfide, molybdenum disulfide, and molybdenum dioxide. Atoms or polyanions in these materials may be partially substituted with atoms or anion species composed of other elements. The surfaces of these materials may be coated with other materials. In the positive active material layer 42, one of these compounds may be used alone, or two or more thereof may be used in mixture.

The positive active material is usually particles (powder). The average particle size of the positive active material is preferably 0.1 μm or more and 20 μm or less, for example. By setting the average particle size of the positive active material to the above lower limit or more, the positive active material is easily manufactured or handled. By setting the average particle size of the positive active material to the above upper limit or less, the electron conductivity of the positive active material layer 42 is improved. When a composite of the positive active material and other material is used, the average particle size of the composite is taken as the average particle size of the positive active material. The “average particle size” means a value when a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher and a classifier and the like are used to obtain a powder having a predetermined particle size. Examples of the crushing method include a method using a mortar, a ball mill, a sand mill, a vibrating ball mill, a planetary ball mill, a jet mill, a counter jet mill, a swirling airflow type jet mill, or a sieve or the like. During crushing, wet crushing in which water or an organic solvent such as hexane coexists can also be used. As a classifying method, both dry-type and wet-type sieves and wind power classifiers and the like are used as necessary.

The content of the positive active material in the positive active material layer 42 is preferably 50% by mass or more and 99% by mass or less, more preferably 70% by mass or more and 98% by mass or less, and still more preferably 80% by mass or more and 95% by mass or less. By setting the content of the positive active material to the above range, both the high energy density and manufacturability of the positive active material layer 42 can be achieved.

(Optional Components)

The conductive agent is not particularly limited as long as it is a material having conductivity. Examples of such a conductive agent include carbonaceous materials, metals, and conductive ceramics. Examples of the carbonaceous material include graphitized carbon, non-graphitized carbon, and graphene-based carbon. Examples of the non-graphitized carbon include carbon nanofibers, pitch-based carbon fibers, and carbon black. Examples of the carbon black include furnace black, acetylene black, and ketjen black. Examples of the graphene-based carbon include graphene, carbon nanotube (CNT), and fullerene. Examples of the shape of the conductive agent include a powder shape and a fiber shape. As the conductive agent, one of these materials may be used alone, or two or more thereof may be used in mixture. These materials may be used in combination. For example, a composite material obtained by combining carbon black and CNT may be used. Among these, carbon black is preferable from the viewpoint of electron conductivity and coatability, and acetylene black is more preferable.

When the conductive agent is used, the content of the conductive agent in the positive active material layer 42 is preferably 1% by mass or more and 10% by mass or less, and more preferably 3% by mass or more and 9% by mass or less. By setting the content of the conductive agent to the above range, the energy density of the secondary battery can be increased.

Examples of the binder include fluororesins (polytetrafluoroethylene (PTFE) and polyvinylidene fluoride (PVDF) and the like), thermoplastic resins such as polyethylene, polypropylene, polyacryl, and polyimide; elastomers such as ethylene-propylene-diene rubber (EPDM), sulfonated EPDM, styrene butadiene rubber (SBR), and fluoro rubber; and polysaccharide polymers. Among these, solvent-based binders such as a fluororesin (polytetrafluoroethylene (PTFE) and polyvinylidene fluoride (PVDF) and the like) are preferable.

When the binder is used, the content of the binder in the positive active material layer 42 is preferably 1% by mass or more and 10% by mass or less, and more preferably 3% by mass or more and 9% by mass or less. By setting the content of the binder to the above range, the active material can be stably held.

When the thickener is used, examples of the thickener include polysaccharide polymers such as carboxymethyl cellulose (CMC) and methyl cellulose. When the thickener has a functional group which reacts with lithium or the like, this functional group may be inactivated by methylation or the like in advance.

The filler is not particularly limited. When the filler is used, examples of the filler include polyolefins such as polypropylene and polyethylene, inorganic oxides such as silicon dioxide, alumina, titanium dioxide, calcium oxide, strontium oxide, barium oxide, magnesium oxide, and aluminosilicate, hydroxides such as magnesium hydroxide, calcium hydroxide, and aluminum hydroxide, carbonates such as calcium carbonate, sparingly soluble ionic crystals such as calcium fluoride, barium fluoride, and barium sulfate, nitrides such as aluminum nitride and silicon nitride, and mineral resource-derived substances such as talc, montmorillonite, boehmite, zeolite, apatite, kaolin, mullite, spinel, olivine, sericite, bentonite, and mica, or artificial products thereof.

The positive active material layer 42 may also contain a typical nonmetal element such as B, N, P, F, Cl, Br, or I, a typical metal element such as Li, Na, Mg, Al, K, Ca, Zn, Ga, Ge, Sn, Sr, or Ba, or a transition metal element such as Sc, Ti, V, Cr, Mn, Fe, Co, Ni, Cu, Mo, Zr, Nb, or W as components other than the positive active material, the conductive agent, the binder, the thickener, and the filler.

(Negative Electrode)

The negative electrode 50 includes a negative electrode substrate 51 and a negative active material layer 52 directly disposed on the negative electrode substrate 51 or disposed on the negative electrode substrate 51 with an intermediate layer interposed therebetween. The constitution of the intermediate layer is not particularly limited, and for example, it can be selected from the constitutions exemplified in the positive electrode 40.

In the present embodiment, the negative active material layer 52 is stacked on each of both surfaces of the negative electrode substrate 51.

An end edge of the negative active material layer 52 is disposed outside an end edge of the positive active material layer 42 facing the end edge of the negative active material layer 52 with the separator 60 interposed therebetween.

The negative electrode substrate 51 has conductivity. As the material of the negative electrode substrate 51, metals such as copper, nickel, stainless steel, nickel-plated steel, and aluminum, or alloys thereof are used.

Among these, copper or a copper alloy is preferable. Examples of the negative electrode substrate 51 include a foil and a deposited film, and a foil is preferable from the viewpoint of cost. Therefore, the negative electrode substrate 51 is preferably a copper foil or a copper alloy foil. Examples of the copper foil include a rolled copper foil and an electrolytic copper foil.

The average thickness of the negative electrode substrate 51 is preferably 2 μm or more and 35 μm or less, more preferably 3 μm or more and 30 μm or less, still more preferably 4 μm or more and 25 μm or less, and particularly preferably 5 μm or more and 20 μm or less. By setting the average thickness of the negative electrode substrate 51 to the above range, the strength of the negative electrode substrate 51 and the energy density per volume of the secondary battery can be increased.

The negative active material layer 52 contains a negative active material. The negative active material layer 52 contains optional components such as a conductive agent, a binder, a thickener, and a filler as necessary. The optional components such as a conductive agent, a binder, a thickener, and a filler can be selected from the materials exemplified in the positive electrode 40.

The negative active material layer 52 may also contain a typical nonmetal element such as B, N, P, F, Cl, Br, or I, a typical metal element such as Li, Na, Mg, Al, K, Ca, Zn, Ga, Ge, Sn, Sr, or Ba, or a transition metal element such as Sc, Ti, V, Cr, Mn, Fe, Co, Ni, Cu, Mo, Zr, Ta, Hf, Nb, or W as components other than the negative active material, the conductive agent, the binder, the thickener, and the filler.

The negative active material can be appropriately selected from known negative active materials. As the negative active material for lithium ion secondary battery, a material capable of inserting and extracting lithium ions is usually used. In the present embodiment, the negative active material is a carbonaceous material or lithium titanate. Examples of the negative active material include: lithium titanates such as Li₄Ti₅O₁₂, Li₂TiO₃, and LiTiO₂; and carbonaceous materials such as graphite and non-graphitic carbon (graphitizable carbon or non-graphitizable carbon). In the negative active material layer 52, one of these compounds may be used alone, or two or more thereof may be used in mixture.

In the present embodiment, the negative active material is at least one of a carbonaceous material or lithium titanate, whereby the expansion of the negative electrode due to charge can be suppressed. Therefore, the expansion of the electrode assembly 2 during charge and discharge can be suppressed. Therefore, the pressing force of the inner surface of the case 3 compressing the electrode assembly 2 due to the reaction force of the expansion can be weakened. Therefore, an increase in the air permeance of the separator including a wet film can be suppressed.

The “graphite” refers to a carbonaceous material having an average grid spacing (d₀₀₂) of 0.33 nm or more and less than 0.34 nm for (002) plane determined by an X-ray diffraction method before charge and discharge or in a discharged state. Examples of the graphite include natural graphite and artificial graphite. Artificial graphite is preferable from the viewpoint that a material having stable physical properties can be obtained.

The “non-graphitic carbon” refers to a carbonaceous material having an average grid spacing (d₀₀₂) of 0.34 nm or more and 0.42 nm or less for (002) plane determined by an X-ray diffraction method before charge and discharge or in a discharged state. Examples of the non-graphitic carbon include non-graphitizable carbon and graphitizable carbon. Examples of the non-graphitic carbon include a resin-derived material, a petroleum pitch or a petroleum pitch-derived material, a petroleum coke or a petroleum coke-derived material, a plant-derived material, and an alcohol-derived material.

Here, the “discharged state” refers to a state where an open circuit voltage is 0.7 V or more in a single electrode battery using a negative electrode 50 containing a carbonaceous material as a negative active material as a working electrode and metal Li as a counter electrode. Since the potential of the metal Li counter electrode in the open circuit state is approximately equal to the oxidation-reduction potential of Li, the open circuit voltage of the single electrode battery is approximately equal to the potential of the negative electrode 50 containing the carbonaceous material with respect to the oxidation-reduction potential of Li. That is, the fact that the open circuit voltage of the single electrode battery is 0.7 V or more means that lithium ions which can be inserted and extracted are sufficiently extracted during charge and discharge from the carbonaceous material which is the negative active material.

The “non-graphitizable carbon” refers to a carbonaceous material having the above d₀₀₂ of 0.36 nm or more and 0.42 nm or less.

The “graphitizable carbon” refers to a carbonaceous material having the above d₀₀₂ of 0.34 nm or more and less than 0.36 nm.

The negative active material is preferably non-graphitic carbon. Since the negative active material is non-graphitic carbon having a smaller expansion coefficient during charge, the expansion of the electrode assembly 2 during charge and discharge can be further suppressed. Therefore, the pressing force of the inner surface of the case 3 compressing the electrode assembly 2 due to the reaction force of the expansion can be further weakened. Therefore, the increase in the air permeance of the separator including the wet film can be further suppressed.

The negative active material is usually particles (powder). The average particle size of the negative active material can be, for example, 1 nm or more and 100 μm or less. The average particle size of the negative active material may be 1 μm or more and 100 μm or less. By setting the average particle size of the negative active material to the above lower limit or more, the negative active material is easily manufactured or handled. By setting the average particle size of the negative active material to the above upper limit or less, the electron conductivity of the negative active material layer is improved. A crusher and a classifier and the like are used to obtain a powder having a predetermined particle size. The crushing method and the classifying method can be selected from, for example, the methods exemplified in the above positive electrode 40.

The content of the negative active material in the negative active material layer 52 is preferably 60% by mass or more and 99% by mass or less, and more preferably 90% by mass or more and 98% by mass or less. By setting the content of the negative active material to the above range, both the high energy density and manufacturability of the negative active material layer 52 can be achieved.

(Separator)

The separator 60 can be appropriately selected from known separators. As the separator 60, for example, a separator 60 which is composed of only a substrate layer, or a separator which includes a heat-resistant layer containing heat-resistant particles and a binder and formed on one surface or both surfaces of a substrate layer can be used. As the material of the substrate layer of the separator 60, for example, a porous resin film is preferable from the viewpoint of strength. As the material of the substrate layer of the separator 60, a polyolefin such as polyethylene or polypropylene is preferable from the viewpoint of a shutdown function, and for example, polyimide or aramid or the like is preferable from the viewpoint of resistance to oxidative decomposition. A composite material of these resins may be used as the substrate layer of the separator 60.

The separator 60 includes a substrate layer (separator substrate). The substrate layer of the separator 60 is a wet film.

The wet film of the separator can be manufactured by known manufacturing methods. An example of a method for manufacturing a separator formed only of a wet film as a substrate layer will be shown below. For example, a polymer such as polyethylene or polypropylene, an additive as necessary, and a substance to be extracted such as liquid paraffin are mixed, and the resultant is heated to be melted. The resultant melt is discharged from, for example, a T die, and casted onto a temperature-controlled cooling roll. In this way, a sheet is formed in which the polymer and the liquid paraffin are phase-separated from each other. Then, the sheet is set in a biaxial tenter drawing machine to be biaxially drawn at a predetermined draw ratio to form a film. The biaxial drawing may or may not be simultaneously performed. The film is placed in a solvent (for example, methylene chloride or methyl ethyl ketone or the like) which dissolves the substance to be extracted in the film, so that the substance to be removed is extracted and removed. Furthermore, the solvent is removed by a drying treatment. Subsequently, the film can be introduced into a TD tenter heat fixing machine to be thermally fixed at a predetermined temperature, thereby producing a wet film.

The pores of the wet film manufactured as described above are formed by extracting and removing the substance to be extracted. Therefore, the pores of the wet film are formed so as to three-dimensionally spread regardless of the thickness direction or surface direction of the film. Therefore, for examples, the pores of the wet film tend to be more apt to collapse than the pores of the dry film when a compressive force is applied to the wet film in the thickness direction. Therefore, the separator including the wet film is apt to have an increased air permeance after the compressive force is applied to the separator.

The air permeance of the separator 60 is measured in accordance with, for example, JIS P-8117. For example, using a Garley type air permeance meter, a time (seconds) when 100 cc of air passes within a circle having a predetermined area is measured as the air permeance (seconds/100 cc).

The heat-resistant particles contained in the heat-resistant layer preferably have a mass decrease of 5% or less when heated from room temperature to 500° C. in an air atmosphere of 1 atm, and more preferably have a mass decrease of 5% or less when heated from room temperature to 800° C. in an air atmosphere of 1 atm. Examples of a material having a mass decrease of a predetermined value or less when heated include inorganic compounds. Examples of the inorganic compounds include: oxides such as iron oxide, silicon oxide, aluminum oxide, titanium oxide, barium titanate, zirconium oxide, calcium oxide, strontium oxide, barium oxide, magnesium oxide, and aluminosilicate; hydroxides such as magnesium hydroxide, calcium hydroxide, and aluminum hydroxide; nitrides such as aluminum nitride and silicon nitride; carbonates such as calcium carbonate; sulfates such as barium sulfate; sparingly soluble ion crystals such as calcium fluoride and barium fluoride; covalent crystals such as silicon and diamond; and mineral resource-derived substances such as talc, montmorillonite, boehmite, zeolite, apatite, kaolin, mullite, spinel, olivine, sericite, bentonite, and mica, or artificial products thereof. As the inorganic compound, these substances or complexes thereof may be used alone, or two or more thereof may be used in mixture. Among these inorganic compounds, silicon oxide, aluminum oxide, or aluminosilicate is preferable from the viewpoint of the safety of the energy storage device 1.

The porosity of the separator 60 is preferably 80% by volume or less from the viewpoint of strength, and preferably 20% by volume or more from the viewpoint of discharge performance. Here, the “porosity” is a volume-based value, and means a value measured by a mercury porosimeter.

(Spacer)

As shown in FIGS. 2 and 3, the spacer 70 is disposed between the inner surface of the case 3 (case body 31) and the electrode assembly 2, and is housed in the case 3 (in FIG. 1, the spacer is not shown). The shape of the spacer 70 is, for example, a sheet shape. The two spacers 70 and 70 may be housed in the case 3.

The two spacers 70 and 70 are disposed in the case 3, for example, so as to be in contact with both flat outer surfaces of the flat electrode assembly 2.

The spacer 70 may be fixed to the inner surface of the case by an adhesive or heat welding or the like, or may be simply sandwiched between the electrode assembly 2 and the inner surface of the case to be held by pressures from both the sides.

For example, the entire one surface of the sheet-shaped spacer 70 may be fixed to the inner surface of the case (surface adhesion or the like), and a part of one surface of the sheet-shaped spacer 70 may be fixed to the inner surface of the case by, for example, point adhesion.

In the energy storage device 1 of the present embodiment, an insulating sheet may be disposed in the case 3 so as to cover the inner surface of the case body 31 in order to insulate the electrode assembly 2 and the case 3 from each other. The insulating sheet is, for example, a resin sheet. The insulating sheet is disposed between the inner surface of the case body 31 and the electrode assembly 2. The material of the insulating sheet is not particularly limited as long as it is electrically insulating (non-conductive), and for example, polyolefin resins such as polyethylene and polypropylene, and resins such as polyimide and polyamide can be used. From the viewpoint of manufacturability, polyolefin resins are preferable, and polyethylene (PE) and polypropylene (PP) are more preferable.

The insulating sheet may be formed in a bag shape by bending a sheet-shaped member or fusing or welding a plurality of sheet-shaped members, and disposed in the case body 31.

The spacer 70 may be fixed to the insulating sheet by the surface adhesion or the point adhesion as described above. Here, it is preferable that the spacer 70 and the insulating sheet are made of the same material. In this way, the spacer 70 is easily fixed to the insulating sheet by the surface adhesion or the point adhesion.

The size of the spacer 70 is not particularly limited as long as the spacer 70 can be housed in the case 3. As shown in FIG. 3, when the flat electrode assembly 2 and the spacer 70 housed in the case 3 are viewed in the thickness direction of the electrode assembly 2, the size of one sheet-shaped spacer 70 may be equal to or less than that of the electrode assembly 2. In this case, the sheet-shaped spacer 70 is disposed in the case 3 so that the entire one surface of the spacer 70 is in contact with the flat outer surface of the flat electrode assembly 2.

Similarly, when the electrode assembly 2 and the spacer 70 are viewed as shown in FIG. 3, the ratio of the area of the spacer 70 to the area of the electrode assembly 2 may be 0.6 or more, and is preferably 0.8 or more.

The size of the spacer 70 is within the above range, whereby the space z of the winding center portion of the electrode assembly 2 can be made smaller.

When the electrode assembly 2 and the spacer 70 are viewed as shown in FIG. 3, the ratio of the area of the spacer 70 to the area of the electrode assembly 2 may be 1.0 or less.

In the flat electrode assembly 2, the positive active material layer 42 and the negative active material layer 52 face each other with the separator 60 interposed therebetween. In the winding axis direction of the electrode assembly 2, both end edges of the negative active material layer 52 are disposed outside both end edges of the positive active material layer 42. In other words, both the end parts of the negative active material layer 52 in the winding axis direction have a portion which does not face the positive active material layer 42.

Therefore, the flat electrode assembly 2 has a facing region in which the positive active material layer 42 and the negative active material layer 52 face each other when viewed in the thickness direction. It is preferable that the length of the spacer 70 in the winding axis direction is equal to or greater than that of the facing region, and the spacer 70 is disposed so as to cover the entire facing region in the winding axis direction. In other words, it is preferable that both end edges of the spacer 70 in the winding axis direction overlap with both end edges of the facing region or protrude outward from both the end edges of the facing region when the electrode assembly is viewed in the thickness direction.

Such a constitution can cause the spacer 70 to more sufficiently suppress an increase in a distance between the positive active material layer 42 and the negative active material layer 52. Therefore, it is possible to suppress a non-uniform charge-discharge reaction in the energy storage device.

The winding type electrode assembly 2 having a flat shape includes a flat part 21 in which a sheet-shaped positive electrode 40 and negative electrode 50 are stacked in a flat state, and a folded-back part 22 in which the stacked sheet-shaped positive electrode 40 and negative electrode 50 are folded back. In the folded-back part 22, the positive electrode 40 and the negative electrode 50 are bent so as to surround a winding axis. When the electrode assembly 2 is viewed in the winding axis direction, the folded-back part 22 is disposed in each of both ends of the flat part 21. A boundary portion y is present in a portion where the positive electrode 40 and the negative electrode 50 stacked in the flat part 21 begin to curve along a winding circumferential direction (see FIGS. 2 and 3). The boundary portion y is present at each of four points so as to linearly extend in the winding axis direction.

It is preferable that, when the winding type electrode assembly 2 having a flat shape is viewed in the winding axis direction, both the end edges of the spacer 70 are disposed inside the boundary portion y between the flat part 21 and the folded-back part 22. In other words, it is preferable that the spacer 70 is disposed so that a compressive force is not directly applied to the boundary portion y between the flat part 21 and the folded-back part 22 by the spacer 70.

The boundary portion y between the flat part 21 and the folded-back part 22 is a portion which is less likely to be compressively deformed even if a compressive force is applied to the boundary portion y in the thickness direction of the electrode assembly 2. In other words, the flat part 21 is more apt to be compressively deformed than the boundary portion y between the flat part 21 and the folded-back part 22. Therefore, the end edge of the spacer 70 is disposed inside the boundary portion y between the flat part 21 and the folded-back part 22, whereby the spacer 70 is more likely to apply a force for compressing the electrode assembly 2 from the outside.

As described above, the shape of the spacer 70 is, for example, a sheet shape, and preferably a flat plate shape having no bent part and curved part. The spacer 70 has a flat plate shape, which makes it easy to appropriately adjust the number and thickness and the like of the spacers 70 according to the tolerance in the electrode assembly and inside of the case, whereby the space z of the winding center portion can be easily made small.

The material of the spacer 70 is not particularly limited. The spacer 70 is made of, for example, a resin, and a polyolefin resin such as polyethylene or polypropylene, and a resin such as polyimide or polyamide can be used. The material of the spacer 70 is preferably a polyolefin resin such as polyethylene (PE) or polypropylene (PP) because it has good stability with respect to an electrolyte solution, and is likely to be handled.

The spacer 70 is harder than the separator 60 (substrate layer of the wet film). The hardness can be quantified by a displacement amount when the spacer 70 and the separator 60 are each compressed with a predetermined load (detailed later).

As the displacement amount is smaller, the spacer 70 is harder, and as the displacement amount is greater, the spacer 70 is softer. Therefore, the displacement amount of the spacer 70 is smaller than that of the separator 60.

Since the spacer 70 is harder than the separator 60 as described above, the spacer 70 is less likely to be deformed than the separator 60. Therefore, when a reaction force when the electrode assembly 2 expands causes the inner surface of the case to press the electrode assembly 2 via the spacer 70, the spacer 70 can further suppress the outward expansion of the electrode assembly 2. Therefore, the expansion is likely to be inwardly directed, whereby the space z of the winding center portion of the electrode assembly 2 can be made small.

For example, the hardnesses of the spacer 70 and the separator 60 may be quantified by the following method to quantify a difference between the hardnesses.

Specifically, when the spacer 70 and the separator 60 are each compressed with a load of 7 kN, the displacement amount of the separator 60 may be 0.1 mm/mm or more greater than that of the spacer 70. The difference between the displacement amounts may be 0.3 mm/mm or less.

As described above, when the difference between the displacement amounts is 0.1 mm/mm or more, the spacer 70 is still harder than the separator 60, whereby, for the above-described reason, the outward expansion of the electrode assembly 2 can be further suppressed.

Since the above displacement amount is expressed per 1 mm of the thickness, the thickness of the spacer 70 or the separator 60 when the displacement amount is measured may be different, and may be substantially the same. For example, a plurality of spacers 70 or separators 60 may be stacked, followed by applying a load of 7 kN to the stacked product so as to have a total thickness of about 1 mm or more and 2 mm or less. The area of the indenter when the load is applied may be 3000 mm² or more, or 4000 mm² or less. The surface area of the indenter is preferably 3680 mm².

The two spacers 70 may be disposed in the case 3 so as to sandwich the electrode assembly 2 as described above, or the spacer 70 may be disposed in the case 3 so as to be in contact with only one flat portion (one surface of the flat part) of the flat electrode assembly 2.

The case 3 may be held so as to have a constant size while housing the electrode assembly 2 in the internal space as described above.

The “energy storage device held so as to have a constant size” is set in, for example, an energy storage apparatus 100 constituted by disposing a plurality of energy storage devices 1 so as to be aligned in one direction.

Whether or not the energy storage device 1 is held so as to have a constant size in the energy storage apparatus 100 can be determined by comparison with the similarly designed energy storage apparatus 100. The similarly designed energy storage apparatus 100 means an energy storage apparatus 100 in which the number of a plurality of energy storage devices 1 aligned in one direction is the same (as that of the energy storage apparatus to be compared), and a fixture for fixing the plurality of energy storage devices 1 at a fixed position is configured to have the same shape (as that of the energy storage apparatus to be compared).

Thus, when the difference between the total lengths of the similarly designed energy storage apparatus 100 and the compared energy storage apparatus 100 is less than 3%, the energy storage devices 1 in the compared energy storage apparatus 100 are held so as to have a constant size. Here, the similarly designed energy storage apparatus 100 and the energy storage apparatus 100 to be compared are compared with each other after being appropriately discharged so that the voltage of the energy storage apparatus 100 is the same.

Even when the energy storage apparatus 100 is composed of one energy storage device 1 and a fixture, whether or not the energy storage device 1 is held so as to have a constant size can be determined by comparing the energy storage apparatus 100 with the similarly designed energy storage apparatus 100.

The energy storage device 1 held so as to have a constant size is, for example, each energy storage device 1 constituting the energy storage apparatus as described above.

When the energy storage devices 1 constituting the energy storage apparatus 100 are held so as to have a constant size, it is difficult to individually adjust the pressures applied to the energy storage devices. Therefore, a relatively large pressure may be applied depending on the energy storage device 1. Therefore, the pores of the wet film of the separator 60 included in the electrode assembly 2 are more apt to collapse, which may be apt to cause the increase in the air permeance of the separator 60.

In the present embodiment, the flat electrode assembly 2 is disposed in the case 3 so as to have no gap with the inner surface of the case 3 in the thickness direction. As the case 3, preferably, a case 3 which is less likely to swell is adopted. In other words, in order to hold the energy storage device 1 so as to have a constant size, a case 3 is preferable, in which the volume increase rate of the case 3 after the electrode assembly 2 is housed to that before the electrode assembly 2 is housed is less than a predetermined percentage (for example, less than 10%). The difference between the length of the case before the flat electrode assembly 2 is housed and the length of the case after the flat electrode assembly 2 is housed (the length of the case in the thickness direction of the electrode assembly 2) may be less than 20%. Examples of the case 3 include a prismatic (rectangular parallelepiped) case 3 composed of a metal plate having a thickness of 0.3 mm or more. The case 3 may be composed of a metal plate having a thickness of 1.5 mm or less. Examples of the metal include aluminum (including an aluminum alloy) and stainless steel.

Since the case 3 is less likely to swell, the electrode assembly 2 housed in the case 3 is pressed from the outside. As the electrode assembly 2 is pressed from the outside, the space z of the winding center portion of the electrode assembly 2 becomes narrower.

In the energy storage device 1 of the present embodiment, the preferred ratio occupied by the electrode assembly 2 and the spacer 70 and the like in the thickness direction in the center part of the electrode assembly 2 in a state where the flat electrode assembly 2 and the spacer 70 are housed in the case 3 is preferably as follows.

In detail, it is preferable that the thickness (A) of the electrode assembly 2, the total thickness (B) of the spacer 70, and the distance (C) between the inner surfaces facing each other in the case body 31 satisfy the following relationship in a cross section (cross section shown in FIG. 2) obtained by cutting the energy storage device 1 (state where the electrode assembly 2 is housed in the case 3) in a plane perpendicular to the winding axis direction of the electrode assembly 2.

0.95C≤A+B≤1.00C

B/A=0.01 or more and 0.08 or less

A/C=0.90 or more and 0.99 or less

B/C=0.01 or more and 0.08 or less

(Nonaqueous Electrolyte)

The nonaqueous electrolyte can be appropriately selected from known nonaqueous electrolytes. A nonaqueous electrolyte solution may be used as the nonaqueous electrolyte. The nonaqueous electrolyte solution contains a nonaqueous solvent, and an electrolyte salt dissolved in the nonaqueous solvent.

The nonaqueous solvent can be appropriately selected from known nonaqueous solvents. Examples of the nonaqueous solvent include cyclic carbonate, chain carbonate, carboxylic acid ester, phosphoric acid ester, sulfonic acid ester, ether, amide, and nitrile. As the nonaqueous solvent, those in which some of hydrogen atoms contained in these compounds are replaced with halogen may be used.

Examples of the cyclic carbonate include ethylene carbonate (EC), propylene carbonate (PC), butylene carbonate (BC), vinylene carbonate (VC), vinyl ethylene carbonate (VEC), chloroethylene carbonate, fluoroethylene carbonate (FEC), difluoroethylene carbonate (DFEC), styrene carbonate, 1-phenyl vinylene carbonate, and 1,2-diphenyl vinylene carbonate. Among these, EC or PC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these, DMC or EMC is preferable.

It is preferable to use cyclic carbonate or chain carbonate as the nonaqueous solvent, and it is more preferable to use cyclic carbonate and chain carbonate in combination. By using the cyclic carbonate, the dissociation of the electrolyte salt can be promoted to improve the ionic conductivity of the nonaqueous electrolyte solution. By using the chain carbonate, the viscosity of the nonaqueous electrolyte solution can be suppressed low. When the cyclic carbonate and the chain carbonate are used in combination, the volume ratio between the cyclic carbonate and the chain carbonate (cyclic carbonate:chain carbonate) is preferably within the range of, for example, 5:95 to 50:50.

The electrolyte salt can be appropriately selected from known electrolyte salts. Examples of the electrolyte salt include a lithium salt, a sodium salt, a potassium salt, a magnesium salt, and an onium salt. Among these, the lithium salt is preferable.

Examples of the lithium salt include inorganic lithium salts such as LiPF₆, LiPO₂F₂, LiBF₄, LiClO₄, and LiN(SO₂F)₂, and lithium salts having a halogenated hydrocarbon group such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these, the inorganic lithium salt is preferable, and LiPF₆ is more preferable.

The content of the electrolyte salt in the nonaqueous electrolyte solution is preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, and particularly preferably 0.7 mol/dm³ or more and 1.5 mol/dm³ or less at 20° C. and 1 atm. By setting the content of the electrolyte salt to the above range, the ionic conductivity of the nonaqueous electrolyte solution can be increased.

The nonaqueous electrolyte solution may contain additives in addition to the nonaqueous solvent and the electrolyte salt. Examples of the additive include: halogenated carbonate esters such as fluoroethylene carbonate (FEC) and difluoroethylene carbonate (DFEC); oxalate esters such as lithium bis(oxalate)borate (LiBOB), lithium difluorooxalate borate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partially hydrogenated products of terphenyl, cyclohexylbenzene, t-butylbenzene, t-amylbenzene, diphenyl ether, and dibenzofuran; partially fluorinated products of the aromatic compounds such as 2-fluorobiphenyl, o-cyclohexylfluorobenzene, and p-cyclohexyl fluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, and cyclohexanedicarboxylic anhydride; and ethylene sulfite, propylene sulfite, dimethyl sulfite, propane sultone, propene sultone, butane sultone, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane), 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, tetrakistrimethylsilyl titanate, lithium monofluorophosphate, and lithium difluorophosphate. These additives can be used alone, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to the total mass of the nonaqueous electrolyte solution. By setting the content of the additive to the above range, capacity retention performance after storage at a high temperature and cycle performance can be improved, and safety can be further improved.

The shape of the energy storage device 1 of the present embodiment is not particularly limited, and examples thereof include a cylindrical battery, a laminated film type battery, a prismatic battery, a flat type battery, a coin type battery, and a button type battery.

FIG. 1 shows an energy storage device 1 (nonaqueous electrolyte energy storage device) as an example of a prismatic battery. An electrode assembly 2 including a positive electrode 40 and a negative electrode 50 wound with a separator 60 sandwiched therebetween is housed in a prismatic case 3 (container). The positive electrode 40 is electrically connected to a positive electrode terminal 4 via a positive electrode lead 45. The negative electrode 50 is electrically connected to a negative electrode terminal 5 via a negative electrode lead 55.

<Constitution of Nonaqueous Electrolyte Energy Storage Apparatus>

The energy storage device 1 of the present embodiment can be mounted as a power storage unit 10 (battery module) composed by assembling a plurality of energy storage devices 1 on a power source for automobiles such as electric vehicles (EV), hybrid electric vehicles (HEV), and plug-in hybrid vehicles (PHEV), a power source for electronic devices such as personal computers and communication terminals, or a power source for power storage or the like. In this case, the technique of the present invention may be applied to at least one energy storage device 1 included in the energy storage apparatus 100.

FIG. 5 shows an example of an energy storage apparatus 100 obtained by assembling power storage units 10 obtained by assembling two or more electrically connected energy storage devices 1. The energy storage apparatus 100 may include a bus bar (not shown) which electrically connects two or more energy storage devices 1, and a bus bar (not shown) which electrically connects two or more power storage units 10, and the like. The power storage unit 10 or the energy storage apparatus 100 may include a state monitoring apparatus (not shown) for monitoring the state of one or more energy storage devices 1.

The energy storage apparatus 100 may include a fixture for fixing the plurality of energy storage devices 1 at a fixed position. The energy storage device 1 in the energy storage apparatus 100 may be fixed by the fixture to be held so as to have a constant size.

For example, the energy storage apparatus 100 may include a pair of end plates disposed so as to sandwich the plurality of energy storage devices 1 and 1 aligned in one direction from both end sides in the aligned direction and a frame connecting the pair of end plates. As a result, the energy storage device 1 can be held so as to have a constant size as described above.

<Method for Manufacturing Nonaqueous Electrolyte Energy Storage Device>

A method for manufacturing an energy storage device 1 of the present embodiment can be appropriately selected from known methods. The manufacturing method includes, for example, preparing an electrode assembly 2, preparing a nonaqueous electrolyte, and housing the electrode assembly 2 and the nonaqueous electrolyte in a case 3. Preparing the electrode assembly 2 includes preparing a positive electrode 40 and a negative electrode 50, and laminating or winding the positive electrode 40 and the negative electrode 50 with a separator 60 interposed therebetween to form an electrode assembly 2.

Housing the nonaqueous electrolyte in the case 3 can be appropriately selected from known methods. For example, when a nonaqueous electrolyte solution is used for the nonaqueous electrolyte, the nonaqueous electrolyte solution may be injected from an inlet formed in case 3, followed by sealing the inlet.

### Other Embodiments

The energy storage device of the present invention is not limited to the above embodiment, and the energy storage device may be variously changed within a scope not departing from the gist of the present invention. For example, it is possible to add the constitution of one embodiment to the constitution of another embodiment, or it is possible to substitute a part of the constitution of one embodiment with the constitution of another embodiment or a well-known technique. Furthermore, it is possible to remove a part of the constitution of one embodiment. A well-known technique can be added to the constitution of one embodiment.

In the above embodiment, the case where the energy storage device 1 is used as a nonaqueous electrolyte secondary battery which is chargeable and dischargeable (for example, a lithium ion secondary battery) has been described. However, the kind, shape, size, and capacity and the like of the energy storage device are arbitrary. The present invention can also be applied to various secondary batteries, and capacitors such as electric double layer capacitors or lithium ion capacitors.

### EXAMPLES

Hereinafter, the present invention will be described in more detail with reference to Examples. The present invention is not limited to the following Examples.

As shown below, a nonaqueous electrolyte secondary battery (lithium ion secondary battery) of each of Examples and Comparative Examples was manufactured.

<Manufacture of Battery>

A positive active material layer having a thickness of 81 μm on one side (positive active material: lithium transition metal composite oxide (LiNi_{1/3}Co_{1/3}Mn_{1/3}O₂)) was formed on both surfaces of an aluminum foil having a thickness of 12 μm to produce a positive electrode.

A negative active material layer having a thickness of 78 μm on one side (negative active material:non-graphitizable carbon, graphite, or silicon shown in Table 1) was formed on both surfaces of a copper foil having a thickness of 8 μm to produce a negative electrode.

The positive electrode and the negative electrode were stacked with each other in a state where a separator including a wet polyethylene film having a thickness of 20 μm as a substrate layer was sandwiched therebetween, followed by winding, thereby producing a winding type electrode assembly having a transverse width size of 116 mm, a thickness size of 10.6 mm, and a height size of 57 mm.

Furthermore, two spacers having a thickness of 0.15 mm, a transverse width of 96.0 mm, and a height of 56.3 mm were placed in a case body (transverse width: 120 mm, thickness: 12.5 mm (spacing of internal space in thickness direction: 11.5 mm), height: 65 mm). The two spacers were disposed in the case body so that the flat electrode assembly was sandwiched between the two spacers from both sides when the flat electrode assembly was inserted into the case body. Then, the electrode assembly was inserted into the case body so that the spacers were in contact with each flat surface portion of the electrode assembly, followed by sealing the case.

LiPF₆ was dissolved in a nonaqueous solvent so that a salt concentration was 1.2 mol/L to prepare a nonaqueous electrolyte solution. The nonaqueous electrolyte solution was appropriately injected into the case according to the following measurements. Here, as the nonaqueous solvent, in Example 1 and Comparative Example 2, a mixture of propylene carbonate (PC), dimethyl carbonate (DMC), and ethyl methyl carbonate (EMC) at PC:DMC:EMC=30:35:35 (% by volume) was used. In Example 2 and Comparative Example 1, a mixture of ethylene carbonate (EC), DMC, and EMC at EC:DMC:EMC=30:35:35 (% by volume) was used.

<Measurement of Hardnesses of Spacer and Separator Used for Manufacturing Battery>

In a state where ten spacers having a thickness of 0.15 mm were stacked, a displacement amount of the stacked product was measured after a load of 7 kN was applied to the stacked product by an indenter having a surface area of 3680 mm² using a universal testing machine Autograph (AG-X manufactured by Shimadzu Corporation) and held for 1 minute. The displacement amount per 1 mm of the thickness was calculated.

As a result, the displacement amount (per 1 mm) of the spacer (polypropylene solid body) used in Examples 1 and 2 and Comparative Example 1 was 0.10 mm/mm.

The displacement amount (per 1 mm) of the spacer (polyurethane porous body) used in Comparative Example 2 was 0.77 mm/mm.

Meanwhile, in a state where fifty separators having a thickness of 20 μm (0.020 mm) were stacked, a displacement amount of the stacked product was measured after a load of 7 kN was applied by an indenter having a surface area of 3680 mm² using a universal testing machine Autograph (AG-X manufactured by Shimadzu Corporation) and held for 1 minute. This measured value was taken as the displacement amount per 1 mm of the thickness.

As a result, the displacement amount (per 1 mm) of the separator used in each of Examples and Comparative Examples was 0.21 mm/mm.

### Examples 1 and 2

Lithium ion secondary batteries were manufactured as described above using negative active materials shown in Table 1. A spacer and a separator in Example 1 are the same as those in Example 2.

### Comparative Examples 1 and 2

Lithium ion secondary batteries were manufactured as described above using negative active materials, spacers, and separators shown in Table 1.

In Comparative Example 1, the same spacer and separator as those in Example 1 were used, and the negative active material different from that used in Example 1 was used.

In Comparative Example 2, a porous body (same size) different from that of Example 1 was used as the spacer.

Table 1 shows the results of evaluations described below for the lithium ion secondary batteries of Examples 1 and 2 and Comparative Examples 1 and 2.

TABLE 1

| | Example | Example | Comparative | Comparative |
|---|---|---|---|---|
| | 1 | 2 | Example 1 | Example 2 |
| Kind of separator | Wet film | Wet film | Wet film | Wet film |
| Compressive | 0.10 | 0.10 | 0.10 | 0.77 |
| displacement | mm/mm | mm/mm | mm/mm | mm/mm |
| amount of spacer | | | | |
| (load of 7 kN) | | | | |
| Compressive | 0.21 | 0.21 | 0.21 | 0.21 |
| displacement | mm/mm | mm/mm | mm/mm | mm/mm |
| amount of | | | | |
| separator | | | | |
| (load of 7 kN) | | | | |
| negative active | Non- | Graphite | Si (silicon) | Non- |
| material | graphitizable | | | graphitizable |
| | carbon | | | carbon |
| Space width of | 0.10 mm | 0.10 mm | 0.10 mm | 0.90 mm |
| winding center | | | | |
| portion | | | | |
| Reaction force | 3792N | 5458N | 17949N | 3792N |
| value to electrode | | | | |
| assembly in | | | | |
| charged state | | | | |
| Increase rate of | 0.43% | 1.03% | 15.20% | 0.43% |
| air permeance | | | | |
| of separator [%] | | | | |

<Measurement of Space Width of Winding Center Portion of Electrode Assembly>

The case was held so as to have a constant size so that the case into which the electrode assembly was inserted had a size before the electrode assembly was inserted. In the state, an X-ray CT image of the winding center portion of the electrode assembly was acquired using an X-ray CT scanning device (microfocus X-ray CT system inspeXio SMX-225CT FRD HR Plus manufactured by Shimadzu Corporation). The X-ray CT image was acquired from a cross section of the wound electrode assembly when cut on a plane perpendicular to a direction connecting folded parts. In other words, in FIG. 2, the cross section when the electrode assembly was cut was acquired along a virtual plane directed in the vertical direction.

In the acquired X-ray CT image, a region having a width of 1 mm between a point of 34.5 mm and a point of 35.5 mm from the end edge of the negative active material layer toward the inside was image-processed. Specifically, the image was binarized in order to distinguish between the electrode and separator portions in the region and the space of the winding center portion of the electrode assembly.

The space width of the winding center portion was calculated by counting the number of pixels (pix) of the space portion represented in black by binarization.

The space width (space size) was calculated using a conversion value of 1 pix=77 μm (1 mm=13 pix). For example, when the number of counted pixels is 200 pix, the space width is (200/13)×0.077=1.185 mm.

<Measurement of Reaction Force Applied as Electrode Assembly Expands>

The battery after the X-ray CT image was acquired was held in a state where the entire long side surface of the case was in contact with a jig equipped with a load cell (LCX-A-ID manufactured by Kyowa Electronic Instruments Co., Ltd.). At this time, the size of the case in which the electrode assembly was housed was held so as to be the same as the size of the case before the electrode assembly was housed. The battery was subjected to constant current charge until the utilization factor of the negative active material was 0.5 to be brought into a charged state. The capacity of the negative active material to be used was 372 mAh/g for non-graphitizable carbon, 372 mAh/g for graphite, and 4200 mA/g for Si as the value when the utilization factor was 1.0.

The value measured by the load cell was taken as the reaction force applied to the electrode assembly in the charged state.

<Measurement of Increase Rate of Air Permeance of Separator>

Apart from the battery manufactured as described above, the electrode assembly of the battery (including the wet film separator) designed in the same manner as in Example 1 and an electrode assembly in which the separator in Example 1 was changed to a dry film (a three-layer structure of polypropylene/polyethylene/polypropylene) having a thickness of 20 μm were prepared.

Using a universal testing machine Autograph (AG-X manufactured by Shimadzu Corporation), a predetermined load (various loads) was applied to each electrode assembly in a case non-insertion state for 1 minute. The electrode assembly after the load was applied was disassembled, and the air permeance of the separator was measured.

The air permeance of each separator to which the load was applied was calculated as a relative value, taking the air permeance of the separator (not used for producing the electrode assembly) before the load was applied as 100%. The results are shown in Tables 2 and 3.

From the plots showing the relationship between the ratios of the calculated air permeabilities and the loads, an approximate curve (quadratic function, intercept: 100) was created by the least squares method.

The reaction force applied to the electrode assembly in the charged state was assumed to be a pressure itself applied to the separator. Using the above approximate curve, the ratio of the air permeance of the separator, which corresponded to the above reaction force value, was obtained, and 100% was subtracted from the ratio of the air permeance to calculate the increase rate of the air permeance of each battery (see Table 1).

TABLE 2
<Wet film>

| Load [kN] | 0 | 4 | 6 | 8 | 10 | 19 |
|---|---|---|---|---|---|---|
| Air permeance [sec · 100 | 85.0 | 85.3 | 87.0 | 86.7 | 88.3 | 99.7 |
| cc⁻¹] | | | | | | |
| Ratio of air permeance [%] | 100.0 | 100.4 | 102.4 | 102.0 | 103.9 | 117.3 |

TABLE 3
<Dry film>

| Load [kN] | 0 | 4 | 6 | 8 | 10 | 15 | 19 |
|---|---|---|---|---|---|---|---|
| Air permeance [sec · | 164.0 | 163.5 | 163.0 | 163.5 | 164.0 | 164.0 | 164.5 |
| 100 cc⁻¹] | | | | | | | |
| Ratio of air permeance | 100.0 | 99.7 | 99.4 | 99.7 | 100.0 | 100.0 | 100.3 |
| [%] | | | | | | | |

As can be seen from Table 1, in the energy storage device of the present embodiment, the space of the winding center portion of the electrode assembly was relatively small, and the increase in the air permeance of the separator including the wet film was suppressed.

As can be seen from Tables 2 and 3, the energy storage device (battery) including the separator including the wet film as the substrate layer can be said to have a peculiar problem that it is more apt to have an increased separator air permeance than the energy storage device including the dry film separator is.

What is claimed is:

1. An energy storage device comprising:
a winding type electrode assembly including a negative electrode containing a negative active material, a positive electrode, and a separator disposed between the positive electrode and the negative electrode;
a case housing the electrode assembly; and
a spacer disposed between the electrode assembly and an inner surface of the case in the case,
wherein the separator includes a wet film,
the negative active material is a carbonaceous material or lithium titanate, and
the spacer is harder than the separator.

2. The energy storage device according to claim 1, wherein the negative active material is non-graphitic carbon as the carbonaceous material.

3. The energy storage device according to claim 1, wherein the case is held so as to have a constant size.

4. The energy storage device according to claim 1, wherein a displacement amount of the separator is more than that of the spacer by 0.1 mm/mm or more when the spacer and the separator are each compressed under a load of 7 kN with an indenter having a surface area of 3680 mm².

5. The energy storage device according to claim 1, wherein
the case is made of a metal,
the energy storage device further comprises an insulating sheet which covers the electrode assembly and insulates between the electrode assembly and the case, and
the spacer is disposed between the electrode assembly and the insulating sheet.
